(19) United States
(12) Patent Application Publication
(10) Pub. No.: US 2025/0074529 A1
(43) Pub. Date: Mar. 6, 2025

(54) AUXILIARY ASSEMBLY FOR BICYCLE

(71) Applicant: C-TECH UNITED CORPORATION, New Taipei City (TW)

(72) Inventors: CHIH-KUN YANG, New Taipei City (TW); CHUN-HUNG CHOU, New Taipei City (TW); HSIN-DAI PAN, New Taipei City (TW)

(21) Appl. No.: 18/457,357

(22) Filed: Aug. 29, 2023

(51) Int. Cl. B62J 43/30; B62J 1/08; B62J 45/41; B62J 45/415; B62J 45/421; B62L 3/00; B62M 25/08; H02J 7/00; H04B 1/3822

(52) U.S. Cl. CPC B62J 43/30; B62J 1/08; B62J 45/41; B62J 45/415; B62J 45/421; B62L 3/00; B62M 25/08; H02J 7/0048; H02J 7/005; H02J 7/0063; H02J 7/00712; H04B 1/3822; B62J 2001/085; B62J 45/42; B62K 25/08

(57) ABSTRACT

An auxiliary assembly for a bicycle includes an auxiliary device installed on the bicycle and a battery device. The auxiliary device includes a first wireless transmission module and an information retrieval module. The information retrieval module can obtain multiple pieces of riding information of the bicycle within a period of time and transmit the same through the first wireless transmission module. The battery device includes a second wireless transmission module and a management module. The second wireless transmission module can receive the multiple pieces of the riding information via the first wireless transmission module. The management module can obtain the multiple pieces of the riding information and compare two of the multiple pieces of the riding information that are close in time, so as to calculate correction data and transmit the same to the auxiliary device through the second wireless transmission module for a follow-up action.

### FIELD OF THE DISCLOSURE

The present disclosure relates to an auxiliary assembly, and more particularly to an auxiliary assembly for a bicycle.

### BACKGROUND OF THE DISCLOSURE

A conventional bicycle is equipped with various auxiliary devices, such as electric gear shifting systems, automatic suspension adjustment devices, electric seat adjustment systems, and ABS brake control systems. However, riders (especially beginners) often do not know how to adjust each of the auxiliary devices to an appropriate setting, which can result in a subpar riding experience. Hence, the auxiliary devices can be connected to a mobile device of the rider via BLUETOOTH, so that a computing unit of the mobile device can adjust each of the auxiliary devices.

However, since mobile devices have different specifications, delays may occur due to insufficient computing power of the computing unit. Furthermore, the power of the mobile device not only needs to maintain basic functions (e.g., positioning or communication), but is also required to continuously power the computing unit for appropriate adjustment and data collection of the auxiliary devices. Under this circumstance, a battery life of the mobile device can be insufficient, such that the operation of the auxiliary devices is negatively affected.

### SUMMARY OF THE DISCLOSURE

In response to the above-referenced technical inadequacies, the present disclosure provides an auxiliary assembly for a bicycle.

In order to solve the above-mentioned problems, one of the technical aspects adopted by the present disclosure is to provide an auxiliary assembly for a bicycle. The auxiliary assembly includes at least one auxiliary device and a battery device. The at least one auxiliary device is configured to be installed on the bicycle. The at least one auxiliary device includes a first wireless transmission module and an information retrieval module that is electrically coupled to the first wireless transmission module, and the information retrieval module is configured to obtain multiple pieces of riding information of the bicycle within a period of time and to transmit the multiple pieces of the riding information through the first wireless transmission module. The battery device is configured to be installed on the bicycle, and the battery device includes a second wireless transmission module and a management module. The second wireless transmission module is capable of receiving the multiple pieces of the riding information via the first wireless transmission module. The management module is electrically coupled to the second wireless transmission module. The management module is configured to obtain the multiple pieces of the riding information and to compare two of the multiple pieces of the riding information that are close in time, so as to calculate correction data and transmit the correction data to the at least one auxiliary device through the second wireless transmission module for a follow-up action.

Therefore, in the auxiliary assembly provided by the present disclosure, by virtue of “the information retrieval module being configured to obtain multiple pieces of riding information of the bicycle within a period of time and to transmit the multiple pieces of the riding information through the first wireless transmission module” and “the management module being configured to obtain the multiple pieces of the riding information and to compare two of the multiple pieces of the riding information that are close in time, so as to calculate correction data and transmit the correction data to the at least one auxiliary device through the second wireless transmission module for a follow-up action,” the auxiliary assembly for the bicycle can directly perform local operations on the at least one auxiliary device through the battery device, thereby ensuring the working time of the at least one auxiliary device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of an auxiliary assembly for a bicycle according to the present disclosure;

FIG. 2 is a schematic view showing the auxiliary assembly being installed on the bicycle according to the present disclosure;

FIG. 3 is a graph illustrating a relationship between an ampere-hour and a temperature of a battery device according to the present disclosure;

FIG. 4 is a block diagram of a transmission system according to the present disclosure;

FIG. 5 is a block diagram of a shock absorber system according to the present disclosure;

FIG. 6 is a block diagram of a lifting system according to the present disclosure;

FIG. 7 is a block diagram of a power system according to the present disclosure; and

FIG. 8 is a block diagram of a brake regulation system according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

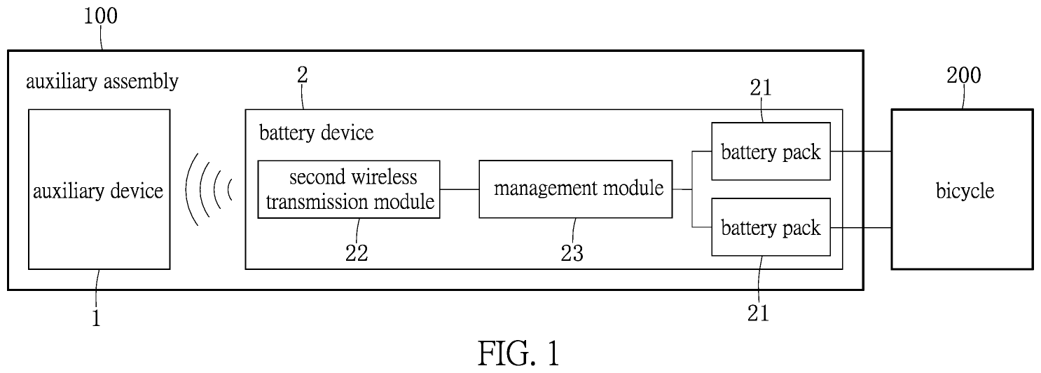

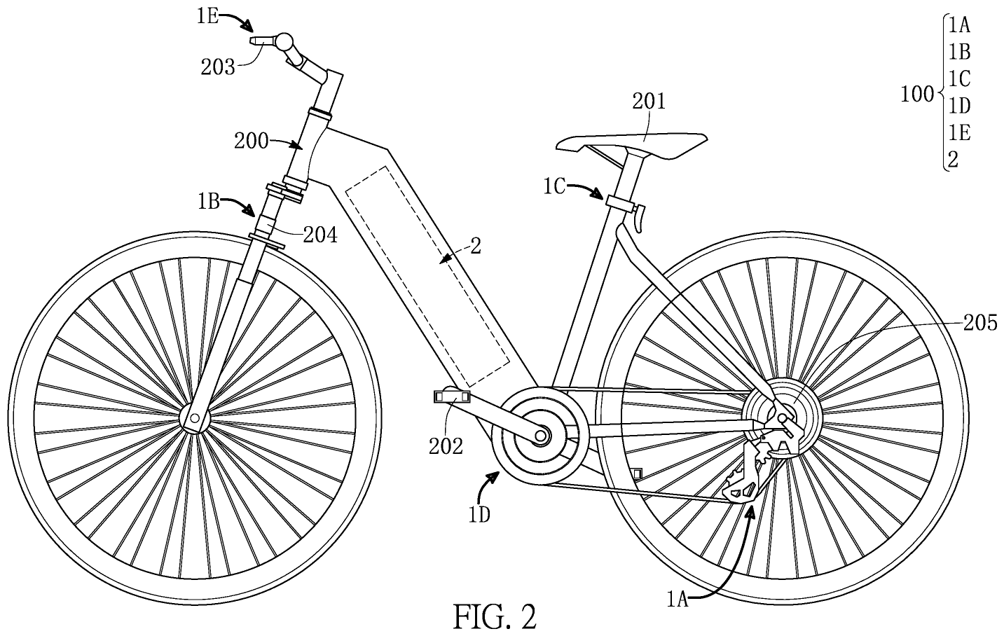

Referring to FIG. 1 to FIG. 8, the present disclosure provides an auxiliary assembly 100 for a bicycle. As shown in FIG. 1 and FIG. 2, the auxiliary assembly 100 includes an auxiliary device 1 and a battery device 2. The auxiliary device 1 uses an arithmetic unit of the battery device 2 to perform local calculations, thereby correcting the riding experience. The following description describes the structure and connection relation of each component of the auxiliary assembly 100.

The auxiliary device 1 is configured to be installed on a bicycle 200. The auxiliary device 1 includes a first wireless transmission module 11 (e.g., transmitters of communication protocols such as Bluetooth, WI-FI, and Zigbee), and an information retrieval module 12 that is electrically coupled to the first wireless transmission module 11. The information retrieval module 12 can obtain multiple pieces of riding information of the bicycle 200 within a period of time, and transmit the multiple pieces of the riding information to the battery device 2 through the first wireless transmission module 11.

Referring to FIG. 1 and FIG. 2, the battery device 2 is configured to provide power for driving the bicycle 200, and the battery device 2 includes two battery packs 21, a second wireless transmission module 22, and a management module 23. The two battery packs 21 can be controlled by the management module 23 to supply power to the bicycle 200. Preferably, the two battery packs 21 can be powered in turn.

Specifically, the management module 23 in the present embodiment is a battery management system and has both computational and storage capabilities. The management module 23 can obtain information of each of the two battery packs 21, so as to control one of the two battery packs 21 to supply power to the bicycle 200 and to control another one of the two battery packs 21 to suspend operation. Accordingly, one of the two battery packs that is suspended from operation can perform a cooling action, and then be used to replace another one of the two battery packs 21 that supplies power.

In detail, the management module 23 can obtain a battery health data for each of the two battery packs 21. When the management module 23 detects that a first variation between two battery health data is greater than 2%, the management module 23 selects one of the two battery packs 21 in which the battery health data is high to supply power to the bicycle 200, and another one of the two battery packs 21 in which the battery health data is low is controlled to suspend operation. Conversely, when the management module 23 detects that the first variation between the two battery health data is less than 2%, the management module selects one of the two battery packs 21 to supply power to the bicycle according to a first rule (which will be described later).

It should be noted that each of the two battery health data in the present embodiment is represented by a relationship of G×Δv/Δi, Δv represents a sampled voltage variation of each of the two battery packs 21 within a unit of time, Δi represents a sampled current variation of each of the two battery packs 21 within a unit of time, and G represents an ideal weighted value obtained through Taguchi methods.

Then, the personnel can write the ideal weighting value into the management module 2, and the management module 23 can perform weighted calculation after obtaining the sampled voltage variation of each of the two battery packs 21 within the unit of time and the sampled current variation of each battery pack 21 within the unit of time, so as to obtain the battery health data. Accordingly, the management module 23 can obtain the battery health data for each of the two battery packs 21 at different time points, and compare the two pieces of the battery health data for the two battery packs 21.

Preferably, the management module 23 can also obtain a piece of battery capacity data for each of the two battery packs 21, so as to determine the first rule. Specifically, in the first rule, when the management module 23 detects that a second variation between the two pieces of the battery capacity data is greater than 50%, the management module 23 selects one of the two battery packs 21 in which the battery capacity data is high to supply power to the bicycle 200, and another one of the two battery packs 21 in which the battery health data is low is controlled to suspend operation. When the management module 23 detects that the second variation between the two pieces of the battery capacity data is less than 50%, the management module 23 selects one of the two battery packs 21 to supply power to the bicycle 200 according to a second rule (which will be described later).

It should be noted that each of the two pieces of the battery capacity data has a relational expression that is Σₜ₌₀^{t=K} i_{c}×t, i_{c} represents a current value of each of the two battery packs 21, and K represents a predetermined time programmed for each of the two battery packs 21, but the present disclosure is not limited thereto.

In a practical application, the management module 23 can also obtain the sampled voltage variation from each of the two battery packs 21 within the unit of time, so as to determine the second rule. The second rule is that the management module 23 selects one of the two battery packs 21 in which the sampled voltage variation is high to supply power to the bicycle 200, and another one of the two battery packs 21 in which the sampled voltage variation is low to suspend operation.

The sampled voltage variation has a relational expression that is V_{C1}−V_{C2}, V_{C1} represents a current voltage value obtained as a steady-state average of the current using Ohm impedance as a reference value, and V_{C2} represents a current voltage value obtained using a current threshold value exceeding a polarization impedance as a reference value.

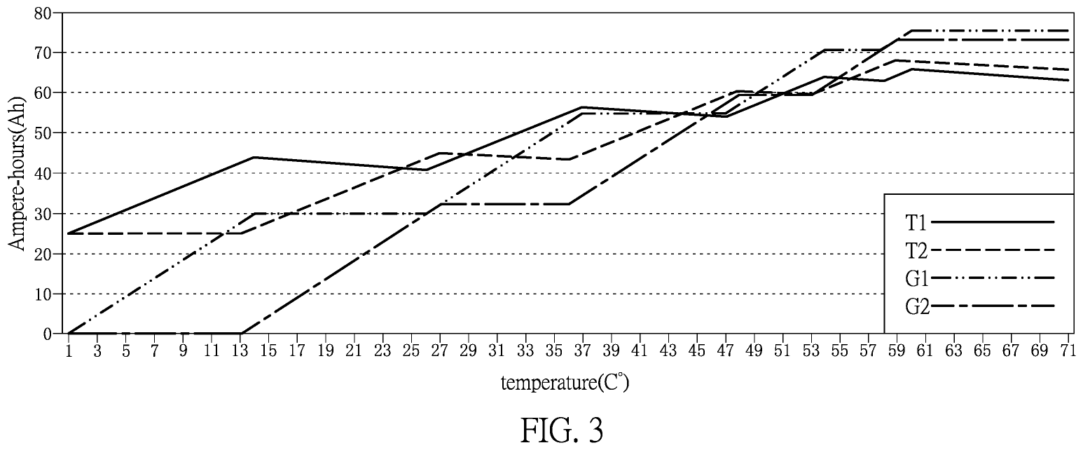

It should be noted that FIG. 3 is a graph showing actual operation of the battery device 2 according to the present disclosure. The horizontal axis represents ampere-hours, and the vertical axis represents temperature. The graph includes two temperature data lines T1, T2 and two capacitance data lines G1, G2 of the two battery packs 21. It can be seen from FIG. 3 that, when the capacitance of each of the two battery packs 21 is between 60 ampere-hours and 85 ampere-hours, the temperature of each of the two battery packs 21 is less than 68° C. In other words, the two battery packs 21 do not reach a peak temperature after being almost fully discharged.

Referring to FIG. 1 and FIG. 2, the second wireless transmission module 22 (e.g., transmitters of communication protocols such as Bluetooth, WI-FI, and Zigbee) can receive multiple pieces of the riding information through the first wireless transmission module 11. The management module 23 can obtain multiple pieces of the riding information, and compare two of the multiple pieces of the riding information that are close in time, so as to calculate correction data and transmit the correction data to the auxiliary device 1 through the second wireless transmission module 22 for a follow-up action.

It should be noted that the follow-up action can have different actions according to different functions of the auxiliary device 1. In the following description, several practical examples are provided for illustrative purposes, but the present disclosure is not limited thereto.

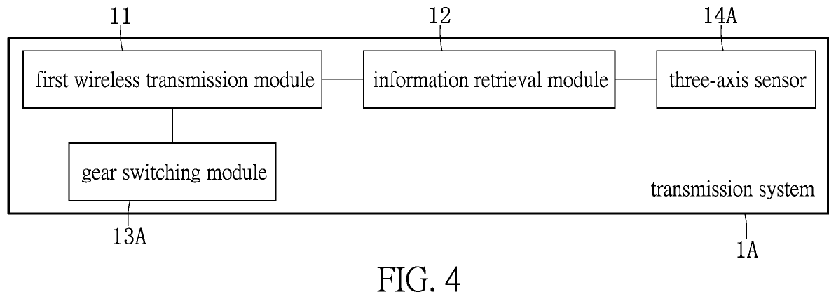

In a practical application, as shown in FIG. 2 and FIG. 4, the auxiliary device 1 may be a transmission system 1A including a gear switching module 13A electrically coupled to the first wireless transmission module 11, and a three-axis sensor 14A that is electrically coupled to the information retrieval module 12. The three-axis sensor 14A is configured to be disposed on the bicycle 200, and to sense changes in a depression angle and elevation angle of the bicycle 200 for generation of a pitch change parameter as the riding information.

The information retrieval module 12 can retrieve the pitch change parameter (i.e., the riding information) every minute during a riding process of a user (i.e., the period of time), and the pitch change parameter is transmitted to the management module 23 through the first wireless transmission module 11 for calculation, so as to obtain an optimal gear combination (i.e., the correction data). When the gear switching module 13A receives the correction data through the first wireless transmission module 11, the gear switching module 13A can change a gear combination of a transmission gear set (not shown) of the bicycle 200 for completing the follow-up action.

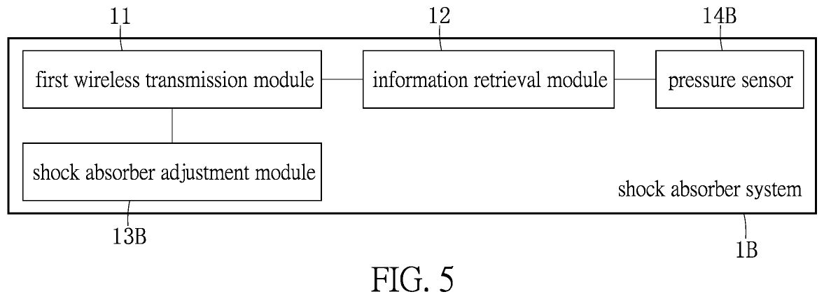

In another practical application, as shown in FIG. 2 and FIG. 5, the auxiliary device 1 may be a shock absorber system 1B, and the shock absorber system 1B includes a shock absorber adjustment module 13B electrically coupled to the first wireless transmission module 11, and a pressure sensor 14B that is electrically coupled to the information retrieval module 12. The pressure sensor 14B is configured to be disposed on a seat cushion 201 of the bicycle 200, and to sense a force parameter of the seat cushion 201 as the riding information. The information retrieval module 12 can retrieve the force parameters (i.e., the riding information) every minute during the riding process of the user (i.e., the period of time), and the force parameters are transmitted to the management module 23 through the first wireless transmission module 11 for calculation, so as to obtain an optimal damping force (i.e., the correction data). When the shock absorber adjustment module 13B receives the correction data through the first wireless transmission module 11, the shock absorber adjustment module 13B is configured to adjust a damping effect of a shock absorber 204 of the bicycle 200 for completing the follow-up action.

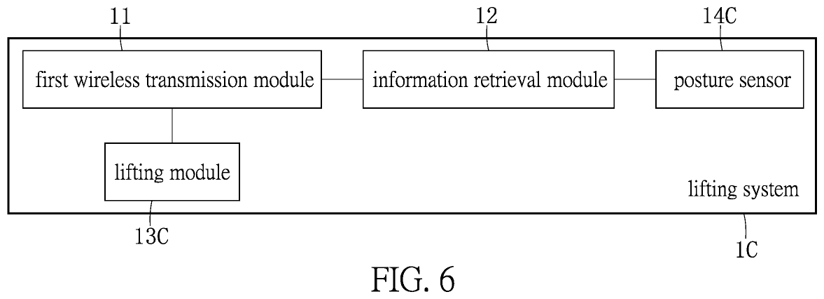

In yet another practical application, as shown in FIG. 2 and FIG. 6, the auxiliary device 1 may be a lifting system 1C, and the lifting system 1C includes a lifting module 13C electrically coupled to the first wireless transmission module 11, and an posture sensor 14C that is electrically coupled to the information retrieval module 12. The posture sensor 14C can be installed on the bicycle 200 and obtain riding posture data of the user as the riding information. For example, the posture sensor 14C can generate simulated riding posture data through a difference between the force of a pedal 202 of the bicycle 200 and the force of the seat cushion 201, but the present disclosure is not limited thereto.

The information retrieval module 12 can capture the riding posture data (i.e., the riding information) every minute during the riding process of the user (i.e., the period of time), and the riding posture data is transmitted to the management module 23 through the first wireless transmission module 11 for calculation, so as to obtain an optimal seating position (i.e., the correction data). When the lifting module 13C receives the correction data through the first wireless transmission module 11, the lifting module 13C can adjust a height position of the seat cushion 201 of the bicycle 200 for completing the follow-up action.

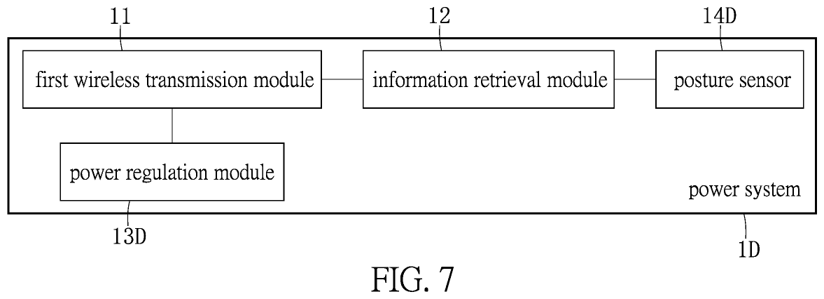

In still another practical application, as shown in FIG. 2 and FIG. 7, the auxiliary device 1 may be a power system 1D, and the power system 1D includes a power regulation module 13D electrically coupled to the first wireless transmission module 11, and a pressure sensor 14D that is electrically coupled to the information retrieval module 12. The pressure sensor 14D can be disposed on the pedal 202 and sense a pedaling cycle parameter as the riding information. The information retrieval module 12 can retrieve the pedaling cycle parameters (i.e., the riding information) every minute during the riding process of the user (i.e., the period of time), and the pedaling cycle parameters are transmitted to the management module 23 through the first wireless transmission module 11 for calculation, so as to obtain a habitual pedaling cycle of the user (i.e., the correction data). When the power regulation module 13D receives the correction data through the first wireless transmission module 11, the power regulation module 13D can adjust an output efficiency of a driver 205 of the bicycle 200, so that the pedaling cycle parameter tends to an ideal state of the user for completing the follow-up action.

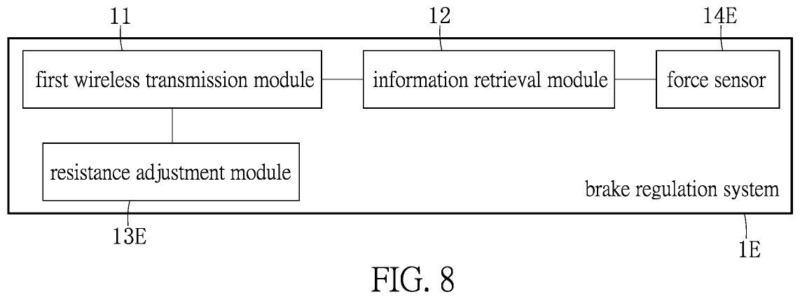

In still yet another practical application, as shown in FIG. 2 and FIG. 8, the auxiliary device 1 may be a brake regulation system 1E, and the brake regulation system 1E includes a resistance adjustment module 13E electrically coupled to the first wireless transmission module 11, and a force sensor 14E that is electrically coupled to the information retrieval module 12. The force sensor 14E can be installed on a brake lever 203 of the bicycle 200, and sense a force change parameter of the brake lever 203 as the riding information. The information retrieval module 12 can capture the force change parameters of the brake lever 203 (i.e., the riding information) every minute during the riding process of the user (i.e., the period of time), and the force change parameters are transmitted to the management module 23 through the first wireless transmission module 11 for calculation, so as to obtain a habitual pressing force of the user (i.e., the correction data). When the resistance adjustment module 13E receives the correction data through the first wireless transmission module 11, the resistance adjustment module 13E can change a resistance of the brake lever 203 of the bicycle 200 for completing the follow-up action.

It should be noted that, in certain embodiments of the present disclosure (not shown), the auxiliary assembly 100 of the bicycle may include multiple ones of the auxiliary device 1 having different functions. That is to say, a quantity of the auxiliary device 1 in the auxiliary assembly 100 of the bicycle is at least one.

### Beneficial Effects of the Embodiment

In conclusion, in the auxiliary assembly provided by the present disclosure, by virtue of “the information retrieval module being configured to obtain multiple pieces of riding information of the bicycle within a period of time and to transmit the multiple pieces of the riding information through the first wireless transmission module” and “the management module being configured to obtain the multiple pieces of the riding information and to compare two of the multiple pieces of the riding information that are close in time, so as to calculate correction data and transmit the correction data to the at least one auxiliary device through the second wireless transmission module for a follow-up action,” the auxiliary assembly for the bicycle can directly perform local operations on the at least one auxiliary device through the battery device, thereby ensuring the working time of the at least one auxiliary device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An auxiliary assembly for a bicycle, comprising:
at least one auxiliary device configured to be installed on the bicycle, wherein the at least one auxiliary device includes a first wireless transmission module and an information retrieval module that is electrically coupled to the first wireless transmission module, and the information retrieval module is configured to obtain multiple pieces of riding information of the bicycle within a period of time and to transmit the multiple pieces of the riding information through the first wireless transmission module; and
a battery device configured to be installed on the bicycle, wherein the battery device includes:
a second wireless transmission module capable of receiving the multiple pieces of the riding information via the first wireless transmission module; and
a management module electrically coupled to the second wireless transmission module, wherein the management module is configured to obtain the multiple pieces of the riding information and to compare two of the multiple pieces of the riding information that are close in time, so as to calculate correction data and transmit the correction data to the at least one auxiliary device through the second wireless transmission module for a follow-up action.

2. The auxiliary assembly according to claim 1, wherein the at least one auxiliary device is further defined as a shock absorber system, and the shock absorber system includes a shock absorber adjustment module electrically coupled to the first wireless transmission module, and a pressure sensor that is electrically coupled to the information retrieval module; wherein the pressure sensor is configured to be disposed on a seat cushion of the bicycle, and to sense a force parameter of the seat cushion as the riding information; wherein, when the shock absorber adjustment module receives the correction data through the first wireless transmission module, the shock absorber adjustment module is configured to adjust a damping effect of a shock absorber of the bicycle for completing the follow-up action.

3. The auxiliary assembly according to claim 1, wherein the at least one auxiliary device is further defined as a lifting system, and the lifting system includes a lifting module electrically coupled to the first wireless transmission module, and an posture sensor that is electrically coupled to the information retrieval module; wherein the posture sensor is configured to be installed on the bicycle, and to obtain riding posture data of a user as the riding information; wherein, when the lifting module receives the correction data through the first wireless transmission module, the lifting module is configured to adjust a height position of the seat cushion of the bicycle for completing the follow-up action.

4. The auxiliary assembly according to claim 1, wherein the at least one auxiliary device is further defined as a power system, and the power system includes a power regulation module electrically coupled to the first wireless transmission module, and a pressure sensor that is electrically coupled to the information retrieval module; wherein the pressure sensor is configured to be disposed on a pedal of the bicycle, and to sense a pedaling cycle parameter as the riding information; wherein, when the power regulation module receives the correction data through the first wireless transmission module, the power regulation module is configured to adjust an output efficiency of a driver of the bicycle, so that the pedaling cycle parameter approaches an ideal state of a user for completing the follow-up action.

5. The auxiliary assembly according to claim 1, wherein the at least one auxiliary device is further defined as a transmission system, and the transmission system includes a gear switching module electrically coupled to the first wireless transmission module, and a three-axis sensor that is electrically coupled to the information retrieval module; wherein the three-axis sensor is configured to be disposed on the bicycle, and to sense changes in a depression angle and an elevation angle of the bicycle for generation of a pitch change parameter as the riding information; wherein, when the gear switching module receives the correction data through the first wireless transmission module, the gear switching module is configured to change a gear combination of a transmission gear set of the bicycle for completing the follow-up action.

6. The auxiliary assembly according to claim 1, wherein the at least one auxiliary device is further defined as a brake regulation system, and the brake regulation system includes a resistance adjustment module electrically coupled to the first wireless transmission module, and a force sensor that is electrically coupled to the information retrieval module; wherein the force sensor is configured to be installed on a brake lever of the bicycle, and to sense a force change parameter of the brake lever as the riding information; wherein, when the resistance adjustment module receives the correction data through the first wireless transmission module, the resistance adjustment module is configured to change a resistance of the brake lever of the bicycle for completing the follow-up action.

7. The auxiliary assembly according to claim 1, wherein the battery device further includes two battery packs electrically coupled to the management module; wherein the management module is configured to obtain a piece of battery health data for each of the two battery packs; wherein, when the management module detects that a first variation between the two pieces of the battery health data is greater than 2%, the management module selects one of the two battery packs in which the battery health data is high to supply power to the bicycle, and another one of the two battery packs in which the battery health data is low is controlled to suspend operation; wherein, when the management module detects that the first variation between the two pieces of the battery health data is less than 2%, the management module selects one of the two battery packs to supply the power to the bicycle according to a first rule.

8. The auxiliary assembly according to claim 7, wherein the management module is configured to obtain a piece of battery capacity data for each of the two battery packs; wherein, in the first rule, when the management module detects that a second variation between the two pieces of the battery capacity data is greater than 50%, the management module selects one of the two battery packs in which the battery capacity data is high to supply the power to the bicycle, and another one of the two battery packs in which the battery capacity data is low is controlled to suspend operation; wherein, in the first rule, when the management module detects that the second variation between the two pieces of the battery capacity data is less than 50%, the management module selects one of the two battery packs to supply the power to the bicycle according to a second rule.

9. The auxiliary assembly according to claim 8, wherein each of the two pieces of the battery health data is represented by a relationship of G×Δv/Δi, Δv represents a sampled voltage variation of each of the two battery packs within a unit of time, Δi represents a sampled current variation of each of the two battery packs within the unit of time, and G represents an ideal weighted value obtained through Taguchi methods; and wherein each of the two pieces of the battery capacity data is represented by a relationship of Σₜ₌₀^{t=K} i_{c}×t, i_{c} represents a current value of each of the two battery packs, and K represents a predetermined time that is programmed for each of the two battery packs.

10. The auxiliary assembly according to claim 8, wherein the management module is configured to obtain a sampled voltage variation from each of the two battery packs within a unit of time; wherein, in the second rule, the management module selects one of the two battery packs in which the sampled voltage variation is high to supply the power to the bicycle, and another one of the two battery packs in which the sampled voltage variation is low is controlled to suspend operation; and wherein the sampled voltage variation is represented by a relationship of V_{C1}−V_{C2}, V_{C1} represents a current voltage value obtained by using an ohm impedance that is a steady-state current average as a reference value, and V_{C2} represents a current voltage value obtained by using a current threshold value that exceeds a polarization impedance as the reference value.
